(19) United States
(12) Patent Application Publication
(10) Pub. No.: US 2026/0273741 A1
(43) Pub. Date: Sep. 17, 2026

(54) DEVICE CONTROL METHOD AND APPARATUS, GRASPING DEVICE, AND STORAGE MEDIUM

(71) Applicant: MOXIAN TECHNOLOGY DONGGUAN CO., LTD., Dongguan (CN)

(72) Inventor: Zheng KUANG, Dongguan (CN)

(21) Appl. No.: 19/672,779

(22) Filed: May 11, 2026

Related U.S. Application Data
(63) Continuation of application No. PCT/CN2024/070880, filed on Jan. 5, 2024.

(30) Foreign Application Priority Data
Dec. 25, 2023 (CN) 2023118057569

(51) Int. Cl. B25J 9/16

(52) U.S. Cl. CPC B25J 9/1653; B25J 9/1669; B25J 9/1694

(57) ABSTRACT

A control method is provided. The method includes: obtaining target position information of at least one preset position obtained by the grasping device contacting a target object from a plurality of directions, and target pressure information corresponding to the target position information; determining target point cloud data of the target object based on the target position information and the target pressure information corresponding to the target position information; and determining a point cloud data model of the target object based on the target point cloud data, so as to identify a grasping object of the grasping device based on the point cloud data model. A control apparatus, a grasping device, and a storage medium are also provided.

### CROSS-REFERENCE TO RELATED APPLICATIONS

This application claims priority to Chinese Patent Application No. 202311805756.9 entitled “Device Control Method and Apparatus, Grasping Device, and Storage Medium” filed with China National Intellectual Property Administration on Dec. 25, 2023, the entire contents of which are incorporated herein by reference.

### TECHNICAL FIELD

The present disclosure relates to the field of equipment automation technologies, and in particular, to a device control method and apparatus, a grasping device, and a storage medium.

### BACKGROUND

When an existing robotic hand grasps an object, perception is usually performed via pressure sensors disposed on the surface of the robotic hand to determine whether the robotic hand has touched the object. However, the inventor has realized that the pressure sensors on the robotic hand in the related art can only determine whether an object is grasped, but cannot obtain more information about the object; auxiliary judgment through operations such as image acquisition of the object is also required, which has certain limitations. There is an urgent need for a more flexible robotic hand capable of analyzing the grasping object.

### SUMMARY OF THE INVENTION

A main objective of the present disclosure is to provide a device control method and apparatus, a grasping device, and a storage medium, aiming to analyze and recognize a grasping object through tactile information of the grasping device, so as to improve the intelligence of the grasping device.

In a first aspect, the present disclosure provides a device control method configured for a grasping device, including the following steps:
obtaining target position information of at least one preset position obtained by the grasping device contacting a target object from a plurality of directions, and target pressure information corresponding to the target position information;
determining target point cloud data of the target object based on the target position information and the target pressure information corresponding to the target position information; and
determining a point cloud data model of the target object based on the target point cloud data, so as to identify a grasping object of the grasping device based on the point cloud data model.

In a second aspect, the present disclosure further provides a device control apparatus, including:
an information acquisition module configured to obtain target position information of at least one preset position obtained by a grasping device contacting a target object from a plurality of directions, and target pressure information corresponding to the target position information;
a point cloud data determination module configured to determine target point cloud data of the target object based on the target position information and the target pressure information corresponding to the target position information; and
a point cloud data modeling module configured to determine a point cloud data model of the target object based on the target point cloud data, so as to identify the grasping object of the grasping device based on the point cloud data model.

In a third aspect, the present disclosure further provides a grasping device, which includes an array of flexible sensors and an inertial measurement unit (IMU), which are disposed over a surface of the grasping device; and further includes a processor, a memory, and a computer program stored in the memory and executable by the processor, wherein the computer program, when executed by the processor, causes the processor to perform the device control method according to any embodiment of the present disclosure.

In a fourth aspect, the present disclosure further provides a computer-readable storage medium storing a computer program, wherein the computer program, when executed by a processor, causes the processor to perform the device control method according to any embodiment of the present disclosure.

The present disclosure provides a device control method and apparatus, a grasping device, and a storage medium. In the present disclosure, target position information of at least one preset position obtained by a grasping device contacting a target object from a plurality of directions, and target pressure information corresponding to the target position information are obtained; target point cloud data of the target object is determined based on the target position information and the target pressure information corresponding to the target position information; and a point cloud data model of the target object is determined based on the target point cloud data, so as to identify the grasping object of the grasping device based on the point cloud data model. By modeling the target object using a position sensor and a pressure sensor on the grasping device to identify the grasping object based on the point cloud data model and determine whether the grasping object is the target object, the intelligence and flexibility of the grasping device are improved, the acquisition of visual information of the grasping object is avoided, and the complexity of grasping object recognition is reduced.

### BRIEF DESCRIPTION OF THE DRAWINGS

To more clearly expound technical solutions of embodiments of the present disclosure, a brief description will be provided below for the drawings that are necessary for illustrating the embodiments. Obviously, the drawings described below are provided for some of the embodiments of the present disclosure, and based on such drawings, those skilled in the art may envisage other drawings without creative effort.

FIG. 1 is a schematic flowchart showing a device control method according to an embodiment of the present disclosure;

FIG. 2 is a schematic structural diagram showing a grasping device according to an embodiment of the present disclosure;

FIG. 3 is a schematic block diagram showing a device control apparatus according to an embodiment of the present disclosure;

FIG. 4 is a schematic block diagram showing a grasping device according to an embodiment of the present disclosure;

FIG. 5 is a schematic block diagram showing another grasping device according to an embodiment of the present disclosure.

### DETAILED DESCRIPTION

The technical solutions in the embodiments of the present disclosure will be clearly and completely described below with reference to the drawings in the embodiments of the present disclosure. Obviously, the described embodiments are some embodiments of the present disclosure, and not all embodiments. Based on the embodiments in the present disclosure, all other embodiments obtained by those skilled in the art without creative efforts shall fall within the protection scope of the present disclosure.

The flowcharts shown in the drawings are merely illustrative and do not necessarily include all contents and operations/steps, nor are they necessarily performed in the order described. For example, some operations/steps may be decomposed, combined, or partially merged, so the actual execution order may change according to actual conditions.

Embodiments of the present disclosure provide a device control method and apparatus, a grasping device, and a storage medium.

Some embodiments of the present disclosure will be described in detail below with reference to the drawings. The following embodiments and features in the embodiments may be combined with each other without conflict.

Referring to FIG. 1, FIG. 1 is a schematic flowchart of a device control method according to an embodiment of the present disclosure. The device control method may be configured for a terminal or a server, so as to control a grasping device to execute the device control method according to any embodiment of the present disclosure through the terminal or the server. The terminal may be an electronic device such as a mobile phone, a tablet computer, a laptop computer, a desktop computer, a personal digital assistant, and a wearable device; the server may be a standalone server, a server cluster, or a cloud server that provides basic cloud computing services such as cloud services, cloud databases, cloud computing, cloud functions, cloud storage, network services, cloud communications, middleware services, domain name services, security services, content delivery network (CDN), and big data and artificial intelligence platforms.

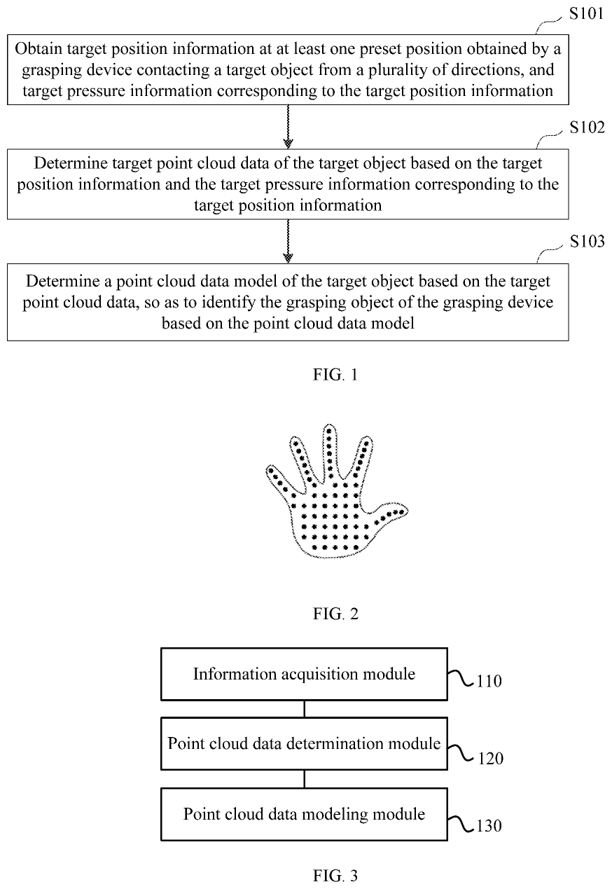

Referring to FIG. 2, FIG. 2 is a schematic structural diagram showing a grasping device according to an embodiment of the present disclosure. As shown in FIG. 2, the grasping device may be a robotic hand simulating the structure of a human hand, such as a flexible robotic hand whose surface can deform, which is not limited herein. The surface of the robotic hand is provided with an array of flexible sensors and an inertial measurement unit (IMU), which are respectively configured to acquire position information and pressure information on the surface of the robotic hand.

As shown in FIG. 1, the device control method includes steps S101 to S103.

Step S101: Obtain target position information of at least one preset position obtained by a grasping device contacting a target object from a plurality of directions, and target pressure information corresponding to the target position information.

In some embodiments, a point cloud data model of the target object can reflect the shape of the target object as a whole. Therefore, when modeling the point cloud data model of the target object, it is necessary to obtain point cloud data of the target object from a plurality of directions. Specifically, target position information and target pressure information are obtained by grasping the target object from a plurality of preset target angles. For example, the target object is grasped from six angles including front, side, left, right, top, and bottom of the target object, so as to obtain target position information and target pressure information of the target object from the six angles.

Contacting the target object from a plurality of directions may be, for example, grasping the target object or touching a specific region of the target object, and the contact manner between the grasping device and the target object is not limited herein.

In some embodiments, target position information at preset positions is obtained via a plurality of inertial measurement units disposed over the surface of the grasping device, and target pressure information at the preset positions is obtained via a plurality of pressure sensors disposed over the surface of the grasping device. The target position information corresponds one-to-one with the target pressure information, and the inertial measurement units and the pressure sensors may be disposed at the same or corresponding positions. Specifically, when an inertial measurement unit and a pressure sensor are disposed at corresponding positions, the target position information corresponding to the target pressure information may be determined based on a position difference between the inertial measurement unit and the pressure sensor.

For example, pressure sensors are disposed on the surface of the grasping device, the inertial measurement units are disposed at a position 0.5 cm below the surface of the grasping device, and the pressure sensors correspond one-to-one with the inertial measurement units. The target position information corresponding to the target pressure information measured by the pressure sensors can be determined based on the position difference of 0.5 cm, which will not be repeated herein.

Certainly, it is not limited thereto, and the target position information at the preset position may also be determined based on a joint posture of the grasping device.

In some embodiments, obtaining the target position information of at least one preset position obtained by a grasping device contacting a target object from a plurality of directions, and target pressure information corresponding to the target position information, includes: obtaining a joint pose associated with at least one preset position; and determining position information of at least one preset position based on the joint pose.

Taking a robotic hand as an example, target position information at a preset position on a single finger may be determined based on the bending degree of a joint on the finger. Specifically, a relative angle corresponding to the preset position is determined based on the bending degree of at least one joint associated with at least one preset position on the finger, and a relative distance corresponding to the preset position is determined based on a distance between the preset position and the joint, thereby determining the target position information of the preset position.

In some embodiments, when the preset position is located at a fingertip of an index finger, joints associated with at least one preset position are three joints located on the index finger; when the preset position is located at a fingertip of a thumb, joints associated with at least one preset position are two joints located on the thumb. Certainly, it is not limited thereto. The preset position is located on a knuckle and is associated with one or two joints on the finger, which is not limited herein.

Step S102: Determine target point cloud data of the target object based on the target position information and the target pressure information corresponding to the target position information.

In some embodiments, target point cloud data of a grasping object is determined based on the one-to-one corresponding target position information and target pressure information. Specifically, the point cloud data obtained by the grasping device is similar to the point cloud data obtained by a lidar. The lidar can obtain three-dimensional coordinates (x, y, z) and light reflection information (intensity) of a plurality of positions on an object. The target point cloud data includes three-dimensional coordinates of the preset position and a pressure value at the preset position.

In some embodiments, target point cloud data of the grasping object is determined so as to be compared with current point cloud data of the grasping object, to determine whether the object grasped by the grasping device is a preset target object, thereby improving the flexibility and intelligence of the grasping device.

Step S103: Determine a point cloud data model of the target object based on the target point cloud data, so as to identify the grasping object of the grasping device based on the point cloud data model.

In some embodiments, since the target point cloud data in the point cloud data model can reflect shapes of the target object in various directions as a whole, when the grasping device performs a grasping operation, no matter from which angle the target object is grasped, the obtained current point cloud data can be matched with the target point cloud data in the point cloud data model to identify the target object.

In some embodiments, determining the grasping object of the grasping device based on the point cloud data model, includes: obtaining current position information of at least one preset position obtained when the grasping device grasps the grasping object, and current pressure information corresponding to the current position information; determining current point cloud information of the grasping object based on the current position information and the current pressure information; matching the point cloud data model of the target object with current point cloud data of the grasping object based on a preset point cloud data matching algorithm; and determining whether the grasping object is the target object based on a matching result of the point cloud data model and the current point cloud data.

In some embodiments, when grasping the grasping object, current point cloud data of a local part of the grasping object is obtained by the method of steps S101-S102, so as to match the current point cloud data with the point cloud data model through a preset point cloud data matching algorithm, so as to determine whether the grasping object is the target object. The type of the point cloud data matching algorithm may be set according to actual needs. For example, the algorithm may be an image recognition algorithm to calculate a similarity between an image formed by the point cloud data model and an image formed by the current point cloud data, or may calculate a relative distance between the target point cloud data and the current point cloud data, which is not limited herein.

In some embodiments, determining whether the grasping object is the target object based on the matching result of the point cloud data model and the current point cloud data, includes: determining that the grasping object is the target object when at least part of target point cloud data in the point cloud data model matches the current point cloud data.

It can be understood that since a grasping device can generally only grasp a part of an object, the current point cloud data obtained by the grasping device is usually also point cloud data of a local part of the grasping object. Therefore, when performing matching, the current point cloud data is matched with at least part of the target point cloud data. That is, as long as there is local target point cloud data in the point cloud data model that matches the current point cloud data, the grasping object is determined to be the target object.

In some embodiments, the current point cloud data obtained by grasping the target object from different angles is usually different. The device control method provided in the embodiments of the present disclosure identifies the grasping object by matching part of the target point cloud data with the current point cloud data, so that the grasping device can identify whether the grasping object is the target object regardless of the grasping angle. The grasping object can be determined without visual assistance through visible light images, thus improving the flexibility of the device control method.

In some embodiments, determining that the grasping object is the target object when at least part of the target point cloud data in the point cloud data model matches the current point cloud data includes: determining that the grasping object is the target object when a point cloud distance between at least part of target point cloud sub-data in the target point cloud data and the current point cloud data is less than or equal to a preset threshold. The number of the target point cloud sub-data is greater than or equal to a preset quantity threshold.

In some embodiments, any part of the target point cloud data in the point cloud data model is matched with the current point cloud data. When the point cloud distance between the current point cloud data and this part of target point cloud data is less than or equal to a preset threshold, the grasping object corresponding to the current point cloud data is determined to be the target object.

The number of target point cloud data used as a determination basis is greater than or equal to a preset quantity threshold. The preset quantity threshold may be, for example, the number of current point cloud data, but it is not limited to this. The minimum number of target point cloud data for determining that the grasping object is the target object may be set according to actual needs, which is not limited herein.

In some embodiments, matching the point cloud data model of the target object with current point cloud data of the grasping object based on the preset point cloud data matching algorithm includes: calculating at least one of a Hausdorff distance, a Chamfer distance, and an Earth Mover's distance between the target point cloud data in the point cloud data model and the current point cloud data based on the preset point cloud data matching algorithm, to obtain a point cloud distance between the target point cloud data and the current point cloud data.

In some embodiments, at least one of the Hausdorff distance (HD), the Chamfer distance (CD), and the Earth Mover's distance (EMD) between a point set formed by the current point cloud data and a point set formed by the target point cloud data is calculated as the point cloud distance between the current point cloud data and the target point cloud data.

Taking the Hausdorff distance as an example, the Hausdorff distance between a set A={a₁, . . . , aₚ} formed by the current point cloud data and a set B={b₁, . . . , b_{q}} formed by the target point cloud data is: H(A, B)=max(h(A, B), h(B, A)), where

$$\{ \begin{matrix}h ( A , B ) = {max}_{a ∈ A} {min}_{b ∈ B} ‖ a - b ‖ \\ h ( B , B ) = {max}_{b ∈ B} {min}_{a ∈ A} ‖ b - a ‖\end{matrix}$$

Alternatively, taking the Chamfer distance as an example, the Chamfer distance between a set S₁ formed by the current point cloud data and a set S₂ formed by the target point cloud data is:

$${d}_{C D} ( {S}_{1} , {S}_{2} ) = \frac{1}{{S}_{1}} {\sum }_{x ∈ {S}_{1}} {min}_{y ∈ {S}_{2}} {‖ x - y ‖}_{2}^{2} + \frac{1}{{S}_{2}} {\sum }_{x ∈ {S}_{2}} {min}_{x ∈ {S}_{1}} {‖ x - y ‖}_{2}^{2}$$

Alternatively, taking the Earth Mover's Distance as an example, the Earth Mover's Distance between a set S₁ formed by the current point cloud data and a set S₂ formed by the target point cloud data is:

$${d}_{E M D} ( {S}_{1} , {S}_{2} ) = {min}_{φ : {S}_{1} \to {S}_{2}} {\sum }_{x ∈ {S}_{1}} {‖ x - φ ( x ) ‖}_{2} , where φ : {S}_{1} \to {S}_{2} is a bijection$$

In some embodiments, after the obtaining current position information of at least one preset position obtained when the grasping device grasps the grasping object, and current pressure information corresponding to the current position information, the method further includes: determining a hardness of the grasping object based on the current pressure information; and determining that the grasping object is not the target object when the hardness of the grasping object does not match a preset hardness of the target object.

In some embodiments, after grasping the grasping object, a preliminary judgment can be made on the grasping object based on the hardness of the grasping object. The hardness of the grasping object is determined based on the current pressure information of the grasping object. For example, the greater the pressure value of the grasping object relative to the grasping device, the higher the hardness of the grasping object, that is, the pressure value is positively correlated with the hardness.

In some embodiments, when the grasping object has a relatively high hardness while the target object is a relatively soft object, and the hardness of the grasping object does not match the preset hardness of the target object, the possibility that the grasping object belongs to the target object is directly excluded without further identification of the grasping object.

In some embodiments, by making a preliminary judgment based on the hardness of the grasping object before object recognition, the judgment logic of the grasping device is similar to the judgment logic of a human palm, avoiding the recognition of grasping objects that are obviously not the target object, reducing the complexity of object recognition and improving recognition efficiency.

The device control method provided in the foregoing embodiments obtains target position information of at least one preset position obtained by a grasping device contacting a target object from a plurality of directions, and target pressure information corresponding to the target position information; determines target point cloud data of the target object based on the target position information and the target pressure information corresponding to the target position information; and determines a point cloud data model of the target object based on the target point cloud data, so as to identify the grasping object of the grasping device based on the point cloud data model. By modeling the target object using a position sensor and a pressure sensor on the grasping device to identify the grasping object based on the point cloud data model and determine whether the grasping object is the target object, the intelligence and flexibility of the grasping device are improved, the acquisition of visual information of the grasping object is avoided, and the complexity of grasping object recognition is reduced.

Referring to FIG. 3, FIG. 3 is a schematic diagram showing a device control apparatus according to an embodiment of the present disclosure. The device control apparatus may be configured in a grasping device to execute the foregoing device control method.

As shown in FIG. 3, the device control apparatus includes: an information acquisition module, a point cloud data determination module, and a point cloud data modeling module.

The information acquisition module is configured to obtain target position information of at least one preset position obtained by a grasping device contacting a target object from a plurality of directions, and target pressure information corresponding to the target position information.

The point cloud data determination module is configured to determine target point cloud data of the target object based on the target position information and the target pressure information corresponding to the target position information.

The point cloud data modeling module is configured to determine a point cloud data model of the target object based on the target point cloud data, so as to identify the grasping object of the grasping device based on the point cloud data model.

It should be noted that those skilled in the art can clearly understand that, for convenience and brevity of description, reference may be made to corresponding processes in the foregoing method embodiments for a specific working process of the above-described apparatus and modules and units, which will not be repeated herein.

The method and apparatus of the present disclosure can be used in a wide variety of general-purpose or special-purpose computing system environments or configurations, such as personal computers, server computers, handheld or portable devices, tablet devices, multiprocessor systems, microprocessor-based systems, set-top boxes, programmable consumer electronic devices, network PCs, minicomputers, mainframe computers, distributed computing environments including any of the above systems or devices, and the like. The present disclosure may be described in the general context of computer-executable instructions executed by a computer, such as program modules. Generally, program modules include routines, programs, objects, components, data structures, etc., that perform specific tasks or implement specific abstract data types. The present disclosure may also be practiced in distributed computing environments where tasks are performed by remote processing devices connected via a communications network. In a distributed computing environment, program modules may be located in both local and remote computer storage media including storage devices.

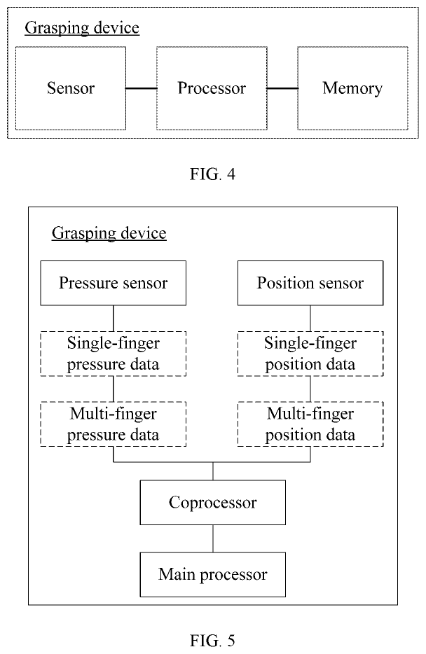

In some embodiments, the above-described method and apparatus may be implemented as a computer program, which may run on a grasping device as shown in FIG. 4.

Referring to FIG. 4, FIG. 4 is a schematic block diagram showing a grasping device according to an embodiment of the present disclosure. The grasping device may be a robotic hand.

As shown in FIG. 4, the grasping device includes a processor, a memory, and sensors connected via a system bus. The memory may include a storage medium and an internal memory, the processor may include a coprocessor and a main processor, and the sensors may include position sensors and pressure sensors.

The storage medium in the memory may store an operating system and a computer program. The computer program includes program instructions that, when executed, cause the processor to perform any one of the device control methods.

The processor is configured to provide computing and control capabilities to support operation of the entire grasping device.

The internal memory provides an environment for execution of the computer program stored in the storage medium, and the computer program, when executed by the processor, causes the processor to perform any one of the device control methods.

The grasping device further includes a position sensor and a pressure sensor, which are disposed over the surface of the grasping device. The position sensor may be, for example, an inertial measurement unit, and the pressure sensor may be, for example, an array of flexible sensors, configured to obtain point cloud information of a grasping object, so that the processor can process the point cloud information.

Those skilled in the art can understand that the structure shown in FIG. 4 is a block diagram showing a part of the structure related to the solution of the present disclosure, and does not constitute a limitation on the grasping device to which the solution of the present disclosure is applied. A specific grasping device may include more or fewer components than those shown in the figure, or combine certain components, or have different component arrangements.

It should be understood that the processor may be a central processing unit (CPU), or the processor may also be other general-purpose processors, digital signal processors (DSPs), application specific integrated circuits (ASICs), field-programmable gate arrays (FPGAs) or other programmable logic devices, discrete gate or transistor logic devices, discrete hardware components, etc. The general-purpose processor may be a microprocessor or the processor may also be any conventional processor or the like.

In one embodiment, the processor is configured to run a computer program stored in the memory to perform the following steps:
obtaining target position information of at least one preset position obtained by a grasping device contacting a target object from a plurality of directions, and target pressure information corresponding to the target position information;
determining target point cloud data of the target object based on the target position information and the target pressure information corresponding to the target position information; and
determining a point cloud data model of the target object based on the target point cloud data, so as to identify the grasping object of the grasping device based on the point cloud data model.

Referring to FIG. 5, which is a schematic block diagram showing another grasping device according to an embodiment of the present disclosure.

As shown in FIG. 5, the grasping device acquires single-finger pressure data and single-finger position data via a pressure sensor and a position sensor respectively, constructs the data into multi-finger pressure data and multi-finger position data, transmits the data to a coprocessor for processing, and then sends the processed pressure data and position data to a main processor to generate a point cloud data map. The coprocessor may be a low-end MCU, and the main processor may be a high-end MCU or a low-end SOC, which is not limited herein.

It should be noted that those skilled in the art can clearly understand that, for convenience and brevity of description, reference may be made to corresponding processes in the foregoing device control method embodiments for a specific working process of the above-described device control, which will not be repeated herein.

An embodiment of the present disclosure further provides a computer-readable storage medium storing a computer program, the computer program including program instructions. For a method implemented when the program instructions are executed, reference may be made to various embodiments of the device control method of the present disclosure.

The computer-readable storage medium may be an internal storage unit of the grasping device described in the foregoing embodiments, such as a hard disk or memory of the grasping device. The computer-readable storage medium may also be an external storage device of the grasping device, such as a plug-in hard drive, a smart media card (SMC), a secure digital (SD) card, a flash card, etc., all of which are provided on the grasping device.

It should be understood that the terminology used in the specification of the present disclosure is for the purpose of describing particular embodiments and is not intended to limit the present disclosure. As used in the specification and the appended claims of the present disclosure, the singular forms “a”, “an” and “the” are intended to include the plural forms unless the context clearly dictates otherwise.

It should be further understood that the term “and/or” used in the specification and the appended claims of the present disclosure refers to any and all possible combinations of one or more of the associated listed items, and includes such combinations. It should be noted that, in this document, the terms “comprise”, “include” or any other variation thereof are intended to cover a non-exclusive inclusion, such that a process, method, article, or system that comprises a list of elements includes not only those elements but also other elements not expressly listed, or elements inherent to such process, method, article, or system. Without further limitation, an element defined by the phrase “comprising a . . . ” does not preclude the existence of other identical elements in the process, method, article, or system that includes the element.

The sequence numbers of the foregoing embodiments of the present disclosure are for description purposes and do not represent the superiority or inferiority of the embodiments. The foregoing are specific embodiments of the present disclosure, but the protection scope of the present disclosure is not limited thereto. Any person skilled in the art who is familiar with the technical field can easily conceive of various equivalent modifications or substitutions within the technical scope disclosed in the present disclosure, and such modifications or substitutions shall fall within the protection scope of the present disclosure. Therefore, the protection scope of the present disclosure shall be subject to the protection scope of the claims.

What is claimed is:

1. A device control method, configured for a grasping device, the method comprising:
obtaining target position information of at least one preset position obtained by the grasping device contacting a target object from a plurality of directions, and target pressure information corresponding to the target position information;
determining target point cloud data of the target object based on the target position information and the target pressure information corresponding to the target position information; and
determining a point cloud data model of the target object based on the target point cloud data, so as to identify a grasping object of the grasping device based on the point cloud data model.

2. The device control method according to claim 1, wherein the obtaining target position information of at least one preset position obtained by the grasping device contacting a target object from a plurality of directions, and target pressure information corresponding to the target position information, comprises:
obtaining a joint pose associated with at least one preset position; and
determining position information of at least one preset position based on the joint pose.

3. The device control method according to claim 1, wherein the determining the grasping object of the grasping device based on the point cloud data model, comprises:
obtaining current position information of at least one preset position obtained when the grasping device grasps the grasping object, and current pressure information corresponding to the current position information;
determining current point cloud information of the grasping object based on the current position information and the current pressure information;
matching the point cloud data model of the target object with current point cloud data of the grasping object based on a preset point cloud data matching algorithm; and
determining whether the grasping object is the target object based on a matching result of the point cloud data model and the current point cloud data.

4. The device control method according to claim 3, wherein the determining whether the grasping object is the target object based on the matching result of the point cloud data model and the current point cloud data, comprises:
determining that the grasping object is the target object when at least part of target point cloud data in the point cloud data model matches the current point cloud data.

5. The device control method according to claim 4, wherein the determining that the grasping object is the target object when at least part of the target point cloud data in the point cloud data model matches the current point cloud data, comprises:
determining that the grasping object is the target object when a point cloud distance between at least part of target point cloud sub-data in the target point cloud data and the current point cloud data is less than or equal to a preset threshold, wherein the number of the target point cloud sub-data is greater than or equal to a preset quantity threshold.

6. The device control method according to claim 3, wherein the matching the point cloud data model of the target object with current point cloud data of the grasping object based on the preset point cloud data matching algorithm, comprises:
calculating at least one of a Hausdorff distance, a Chamfer distance, and an Earth Mover's Distance between target point cloud data in the point cloud data model and the current point cloud data based on the preset point cloud data matching algorithm, to obtain a point cloud distance between the target point cloud data and the current point cloud data.

7.-10. (canceled)

11. The device control method according to claim 4, wherein the matching the point cloud data model of the target object with current point cloud data of the grasping object based on the preset point cloud data matching algorithm, comprises:
calculating at least one of a Hausdorff distance, a Chamfer distance, and an Earth Mover's Distance between target point cloud data in the point cloud data model and the current point cloud data based on the preset point cloud data matching algorithm, to obtain a point cloud distance between the target point cloud data and the current point cloud data.

12. The device control method according to claim 5, wherein the matching the point cloud data model of the target object with current point cloud data of the grasping object based on the preset point cloud data matching algorithm, comprises:
calculating at least one of a Hausdorff distance, a Chamfer distance, and an Earth Mover's Distance between target point cloud data in the point cloud data model and the current point cloud data based on the preset point cloud data matching algorithm, to obtain a point cloud distance between the target point cloud data and the current point cloud data.

13. The device control method according to claim 3, wherein after the obtaining current position information of at least one preset position obtained when the grasping device grasps the grasping object, and current pressure information corresponding to the current position information, the method further comprises:
determining a hardness of the grasping object based on the current pressure information; and
determining that the grasping object is not the target object when the hardness of the grasping object does not match a preset hardness of the target object.

14. The device control method according to claim 4, wherein after the obtaining current position information of at least one preset position obtained when the grasping device grasps the grasping object, and current pressure information corresponding to the current position information, the method further comprises:
determining a hardness of the grasping object based on the current pressure information; and
determining that the grasping object is not the target object when the hardness of the grasping object does not match a preset hardness of the target object.

15. The device control method according to claim 5, wherein after the obtaining current position information of at least one preset position obtained when the grasping device grasps the grasping object, and current pressure information corresponding to the current position information, the method further comprises:
determining a hardness of the grasping object based on the current pressure information; and
determining that the grasping object is not the target object when the hardness of the grasping object does not match a preset hardness of the target object.

16. The device control method according to claim 1, wherein the target position information is obtained via an inertial measurement unit, and the target pressure information is obtained via a pressure sensor.

17. The device control method according to claim 1, wherein the target position information corresponds one-to-one with the target pressure information.

18. A grasping device, comprising an array of flexible sensors and an inertial measurement unit, which are disposed over a surface of the grasping device; and further comprising a processor, a memory, and a computer program stored in the memory and executable by the processor, wherein the computer program, when executed by the processor, causes the processor to perform steps of a device control method; wherein the device control method comprises:
obtaining target position information of at least one preset position obtained by the grasping device contacting a target object from a plurality of directions, and target pressure information corresponding to the target position information;
determining target point cloud data of the target object based on the target position information and the target pressure information corresponding to the target position information; and
determining a point cloud data model of the target object based on the target point cloud data, so as to identify a grasping object of the grasping device based on the point cloud data model.

19. A computer-readable storage medium storing a computer program, wherein the computer program, when executed by a processor, causes the processor to perform steps of a device control method; wherein the device control method comprises:
obtaining target position information of at least one preset position obtained by the grasping device contacting a target object from a plurality of directions, and target pressure information corresponding to the target position information;
determining target point cloud data of the target object based on the target position information and the target pressure information corresponding to the target position information; and
determining a point cloud data model of the target object based on the target point cloud data, so as to identify a grasping object of the grasping device based on the point cloud data model.
